(19) United States
(12) Patent Application Publication
(10) Pub. No.: US 2025/0355089 A1
(43) Pub. Date: Nov. 20, 2025

(54) 3D SENSING APPARATUS WITH AI-CONTROLLED FERROELECTRIC LIQUID CRYSTAL BEAM STEERING FOR ENHANCED DOT ILLUMINATION

(71) Applicant: Goertek Electronics Inc., Santa Clara, CA (US)

(72) Inventors: TAKEO MATSUKAWA, San Jose, CA (US); Kun Gao, Dublin, CA (US)

(73) Assignee: Goertek Electronics Inc., Santa Clara, CA (US)

(21) Appl. No.: 18/663,896

(22) Filed: May 14, 2024

(51) Int. Cl. G01S 7/481; G01S 17/894; G02F 1/135

(52) U.S. Cl. CPC G01S 7/4814; G01S 17/894; G02F 1/135

(57) ABSTRACT

Here discloses a 3D sensing apparatus with AI-controlled Ferroelectric Liquid Crystal beam steering for enhanced dot illumination. The illumination unit for a three-dimensional depth-sensing device includes a light source for emitting an illumination light; a diffuser that diffuses the illumination light into diffused illumination light; and a dual-layer Ferroelectric Liquid Crystal unit, positioned immediately after the diffuser, wherein the dual-layer Ferroelectric Liquid Crystal unit includes a first ferroelectric liquid crystal layer and a second ferroelectric liquid crystal layer, wherein the first ferroelectric liquid crystal layer adjusts a direction of the diffused illumination light, and wherein the second ferroelectric liquid crystal layer corrects a polarization change of the illumination light induced by the first ferroelectric liquid crystal layer. This novel illumination unit features dual-layer Ferroelectric Liquid Crystal technology that enhances the precision and speed of beam steering in 3D depth-sensing devices.

### FIELD OF THE INVENTION

This disclosure relates to the technical field of three-dimensional (3D) sensing, and more specifically, to an illumination unit for a three-dimensional depth-sensing device, and an electronic device comprising the three-dimensional depth-sensing device.

### BACKGROUND OF THE INVENTION

3D depth sensing technologies enable devices and machines to sense their surroundings. Recently, depth measurement and three-dimensional perception have gained importance in many industries and applications. For example, the 3D depth sensing technologies can be used in cleaning robots, robot lawnmower, swimming pool robot, and so on.

Typically, depth sensing devices, like Time-of-Flight (ToF) sensors, consist of a transmitter (TX) or illumination unit and a receiver (RX) or sensor. Commonly, depth sensing devices employ fixed illumination using VCSELs (vertical cavity surface emitting lasers), LEDs, or lasers. These create either flood or dot illumination, and some can scan patterns using a movable mirror. Fixed dot illumination is effective over long distances but loses resolution as distance increases due to the spreading of the light. An alternative method using MEMS scanning with a laser or VCSEL requires complex hardware and software.

### SUMMARY OF THE INVENTION

One object of this invention is to provide a new technical solution for an illumination unit for a three-dimensional depth-sensing device.

According to a first aspect of the disclosure, there is provided an illumination unit for a three-dimensional depth-sensing device, including a light source that emits an illumination light; a diffuser that diffuses the illumination light; and a dual-layer Ferroelectric Liquid Crystal unit, positioned immediately after the diffuser, wherein the dual-layer Ferroelectric Liquid Crystal (FLC) unit includes a first ferroelectric liquid crystal layer and a second ferroelectric liquid crystal layer, wherein the first ferroelectric liquid crystal layer adjusts a direction of the diffused illumination light, and wherein the second ferroelectric liquid crystal layer corrects a polarization change of the illumination light induced by the first ferroelectric liquid crystal layer.

According to a second aspect of the disclosure, there is provided a three-dimensional depth-sensing device comprising the illumination unit according to an embodiment.

According to a second aspect of the disclosure, there is provided an electronic device comprising a three-dimensional depth-sensing device according to an embodiment.

According to an embodiment of this disclosure, an illumination unit can provide quick beam steering. So, this invention introduces a novel illumination unit featuring dual-layer Ferroelectric Liquid Crystal technology that enhances the precision and speed of beam steering in 3D depth-sensing devices.

According to another embodiment of this disclosure, the three-dimensional depth-sensing device can leverage FLC's rapid switching capabilities for quick, precise beam steering.

According to another embodiment of this disclosure, the three-dimensional depth-sensing device can direct the beam in a continuous and smooth manner across the X/Y plane, reaching any specified region.

According to another embodiment of this disclosure, the three-dimensional depth-sensing device will adopt AI algorithms that allow the system to be adapted in real time to changing conditions or targets.

According to another embodiment of this disclosure, the three-dimensional depth-sensing device is ideal for high-speed optical communication, precise LiDAR mapping, advanced imaging systems in medical technology, and augmented reality systems.

Further features of the disclosure and advantages thereof will become apparent from the following detailed description of exemplary embodiments according to the disclosure with reference to the attached drawings.

### BRIEF DESCRIPTION OF THE DRAWINGS

The accompanying drawings, which are incorporated in and constitute a part of the specification, illustrate embodiments of the invention and, together with the description thereof, serve to explain the principles of the invention.

FIG. 1 is a schematic diagram showing the structure of a 3D sensing device.

FIG. 2 illustratively shows a structure of a 3D sensing device.

FIG. 3 schematically shows a block diagram of an illumination unit according to an embodiment.

FIG. 4 schematically shows the dot patterns under different settings of “null point” status and “lit-up” status according to an embodiment.

FIG. 5 schematically shows the dot patterns under different settings, including a right-left pattern, an up-down pattern, and a tilted pattern according to an embodiment.

FIG. 6 schematically shows an example of an electronic device according to an embodiment.

### DETAILED DESCRIPTION OF THE EMBODIMENTS

Various exemplary embodiments of the disclosure will now be described in detail with reference to the drawings. It should be noted that the relative arrangement of the components and steps, the numerical expressions, and the numerical values set forth in these embodiments do not limit the scope of the disclosure unless it is specifically stated otherwise.

The following description of at least one exemplary embodiment is merely illustrative in nature and is in no way intended to limit the invention, its application, or its uses.

Techniques, methods and apparatus as known by one of ordinary skill in the relevant art may not be discussed in detail but are intended to be part of the specification where appropriate.

In all of the examples illustrated and discussed herein, any specific values should be interpreted to be illustrative only and non-limiting. Thus, other examples of the exemplary embodiments could have different values.

Notice that similar reference numerals and letters refer to similar items in the following figures, and thus, once an item is defined in one figure, it is possible that it need not be further discussed for the following figures.

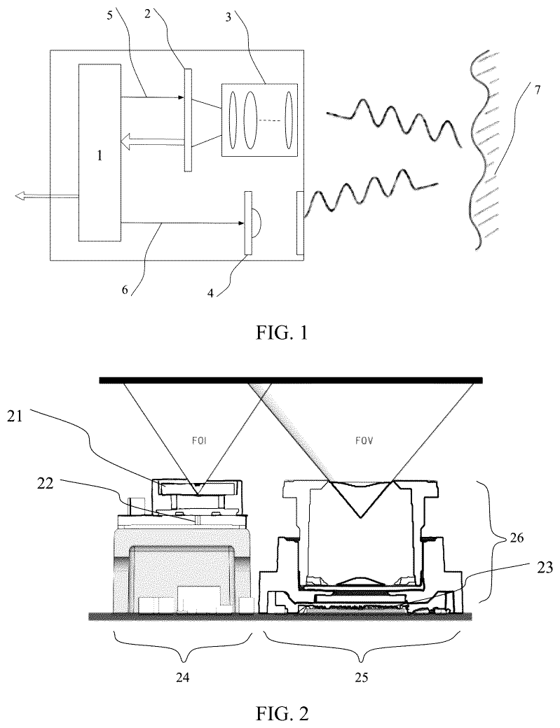

FIG. 1 shows a schematic diagram showing the structure of a 3D sensing device. The 3D sensing device includes a controller 1, an imaging component 2, an imaging lens component 3, and an illumination component 4. The controller 1 sends signal 6 to the illumination component 4 to emit dot light or flood light. The light is incident onto a surface 7 of an object and is reflected back to the imaging lens component 3. Then, the reflected light is received by the imaging component 2. The controller 1 sends compensation signals 5 to the imaging component 2 to instruct the imaging component 2 to compensate the received light to generate the depth data. The controller 1 receives the imaging data from the imaging component 2 and generates a 3D image.

FIG. 2 illustratively shows a structure of a 3D sensing device. As shown in FIG. 2, the 3D sensing device includes an illumination unit (Tx) 24 and an imaging unit 25. The illumination unit 24 includes a light source 22, such as a VCSEL and a diffuser 21. The light source 22 may also include a driver. The diffuser 21 diffuses the light from the light source 22 to form a field of illumination (FOI) and radiate on an object. The imaging unit 25 includes an imaging lens component 26 and an imaging component 23, such as a CMOS image sensor, and receives reflected light from an object in the field of view (FOV). The reflected light is incident on the imaging component 23 via the imaging lens component 26.

An illumination unit of a 3D depth-sensing device, according to an embodiment, uniquely incorporates a dual-layer Ferroelectric Liquid Crystal (FLC) configuration. In another embodiment, the illumination unit incorporating the dual-layer Ferroelectric Liquid Crystal (FLC) configuration is equipped with an AI-enhanced control. This illumination unit can dynamically steer dot illumination with unparalleled precision and speed, significantly enhancing depth-sensing capabilities. According to an embodiment, the integration of FLCs enables fast switching and almost continuous steering across the X/Y axis. According to another embodiment, an Artificial Intelligence (AI) component can precisely direct the dot light to specific regions of interest (ROI), moving beyond conventional left-right and up-down steering limitations. This illumination unit represents a significant advancement in 3D imaging and depth perception. It can be used in applications across various fields including autonomous navigation, medical imaging, and augmented reality.

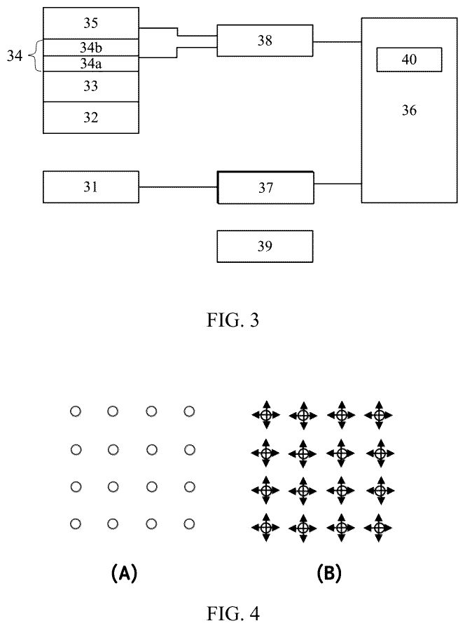

FIG. 3 schematically shows a block diagram of an illumination unit according to an embodiment. As shown in FIG. 3, an illumination unit for a three-dimensional depth-sensing device includes a light source 31, a diffuser 33, and a dual-layer Ferroelectric Liquid Crystal unit 34.

The light source 31 emits an illumination light. The light source 31 is the primary light source for the illumination Tx (transmitter) in the 3D sensing device. Examples of the light source 31 may be a VCSEL or LED light source.

The diffuser 33 diffuses the illumination light. The diffuser 33 may include a Diffractive Optical Element (DOE) or Micro Lens Array (MLA) and can produce a desired dot pattern.

In an embodiment, the illumination unit further comprises a lens unit 32, positioned between the light source 31 and the diffuser 33, and adjusts an optical characteristic of the illumination light to be adapted to the diffuser. For example, the lens unit 32 includes a collimating lens to shape the illumination light before it reaches the diffuser 33.

The dual-layer Ferroelectric Liquid Crystal unit 34 is positioned immediately after the diffuser 33. The dual-layer Ferroelectric Liquid Crystal unit 34 includes a first ferroelectric liquid crystal layer 34a and a second ferroelectric liquid crystal layer 34b. The first ferroelectric liquid crystal layer 34a adjusts a direction of the diffused illumination light. The second ferroelectric liquid crystal layer 34b corrects a polarization change of the illumination light induced by the first ferroelectric liquid crystal layer 34a.

As shown in FIG. 3, the illumination unit may further comprise a control unit 36. The control unit 36 is coupled directly or indirectly to the dual-layer Ferroelectric Liquid Crystal unit 34. The control unit 36 sends control signals to the dual-layer Ferroelectric Liquid Crystal unit 34 to control at least one of the first ferroelectric liquid crystal layer and the second ferroelectric liquid crystal layer to steer the illumination light to desired regions of interest.

As shown in FIG. 3, the illumination unit may further comprise a first driver 37 to drive the light source 31 and a second driver 38 to drive the dual-layer Ferroelectric Liquid in Crystal unit 34. The illumination unit may further comprise a power unit to supply power to respective components.

In an embodiment, the control unit further comprises an AI component 40. The control signals for controlling the dual-layer Ferroelectric Liquid Crystal unit 34 are generated directly or indirectly by the AI component 40. For example, the AI component 40 generates the control signals to control the dual-layer Ferroelectric Liquid Crystal unit 34 to steer the illumination light to desired regions of interest, based on input parameters or real-time image analysis of an image from a receiver for the three-dimensional depth-sensing device.

In an embodiment, the first ferroelectric liquid crystal layer 34a adjusts the direction of the diffused illumination light by altering a phase of the illumination light.

In an embodiment, the time period for steering the illumination light to desired regions of interest by the dual-layer Ferroelectric Liquid Crystal unit is less than 1 ms. Unlike the prior direction steering approaches, the illumination unit with the dual-layer Ferroelectric Liquid Crystal unit can achieve quick steering. Especially, when the time period is less than 1 ms, it is suitable to be co-operated with the AI component to achieve real-time steering and improve the user experience.

As shown in FIG. 3, the illumination unit may further comprise a tunable lens unit 35, positioned after the dual-layer Ferroelectric Liquid Crystal unit and directly or indirectly coupled to the control unit 36. The tunable lens unit 35 may adjust an optical characteristic of the illumination light to a desired status.

FIG. 4 schematically shows the dot patterns under different settings according to an embodiment. In FIG. 4(A), the dual-layer Ferroelectric Liquid Crystal unit 34 is set in default or “null point” status and generates a dot pattern based on the intrinsic characteristics of the diffuser 33. In FIG. 4(B), the dual-layer Ferroelectric Liquid Crystal unit 34 receives the control signal from the controller 36 and is set in a “lit-up” status to generate a pattern to steer the illumination light.

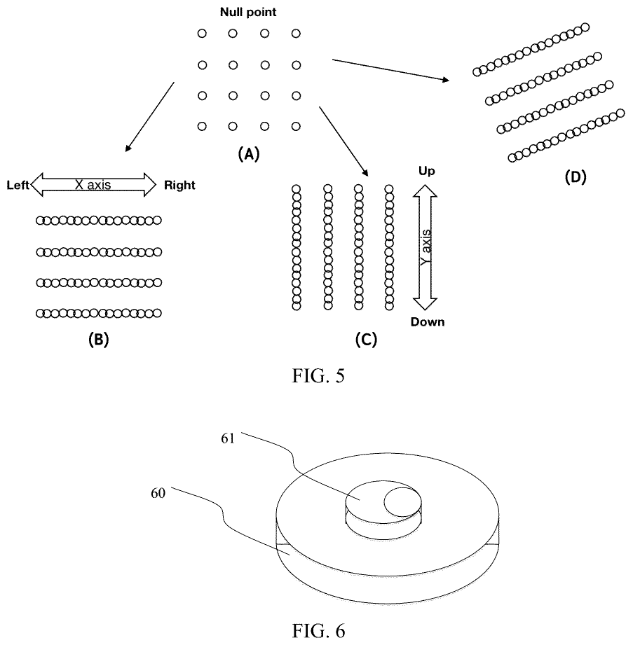

FIG. 5 schematically shows the dot pattern under different settings according to an embodiment. FIG. 5 shows examples in which the dual-layer Ferroelectric Liquid Crystal unit 34 steers the beam directions in different ways.

In FIG. 5(A), the dual-layer Ferroelectric Liquid Crystal unit 34 is set in default or “null point” status and generates a dot pattern based on the intrinsic characteristics of the diffuser 33. In FIG. 5(B), the dual-layer Ferroelectric Liquid Crystal unit 34 steers the beam of the illumination light in right-left directions under the control of the control unit 36. In FIG. 5(C), the dual-layer Ferroelectric Liquid Crystal unit 34 steers the beam of the illumination light in up-down directions under the control of the control unit 36. In FIG. 5(D), the dual-layer Ferroelectric Liquid Crystal unit 34 steers the beam of the illumination light in tilted directions under the control of the control unit 36.

In various embodiments, the illumination unit uses a dual-layer Ferroelectric Liquid Crystal unit with rapid switching capabilities to achieve quick beam steering. In other embodiments, the illumination unit is further equipped with an AI component to achieve precise beam steering.

As explained above, the illumination unit allows for a multidimensional control. It can direct the beam of the illumination light in a continuous and smooth manner across the X/Y plane, reaching any specified region.

By the combination of the dual-layer Ferroelectric Liquid Crystal unit and the AI component, it can further achieve real-time adaptability. The AI component allows the illumination unit to adapt in real time to changing conditions or targets, and the dual-layer Ferroelectric Liquid Crystal unit can respond to the control of the AI component timely.

A 3D sensing device with such an illumination unit will have a wide range of applications, such as high-speed optical communication, precise LiDAR mapping, advanced imaging systems in medical technology, and augmented reality systems.

In various embodiments, the advantages of FLC's rapid response times for beam steering are gained while their limitations in phase and polarization control are overcome. This results in an illumination unit that can accurately and quickly direct a beam to any desired point within its operational plane.

In an embodiment, the dual-layer Ferroelectric Liquid Crystal unit 34 is positioned immediately after the diffuser. The first ferroelectric liquid crystal layer 34a serves as a fast-switching, electrically controllable beam-steering mechanism that can adjust the direction of the emitted light with precision and speed. This layer operates by rapidly reorienting the ferroelectric liquid crystal molecules in response to an electrical signal, thereby altering the phase of the outgoing light to steer the beam. The second ferroelectric liquid crystal layer 34b is dedicated to correcting any polarization changes induced by the first, ensuring that the light's polarization state remains consistent with the required application.

At the default or “null point” setting of the illumination unit 34, the ferroelectric liquid crystal layers are aligned to generate a dot pattern based on the intrinsic characteristics of the diffuser. Upon receiving a control signal, the AI component can adjust the FLC layers' orientation in real time. This dynamic adjustment not only steers the beam towards the targeted direction but also maintains the fidelity of the light's polarization, which can provide accurate depth sensing.

This illumination unit with FLC-AI controlled transmission configuration allows for a responsive and versatile illumination system and is capable of being adapted to different environments and applications, thereby enhancing the 3D depth-sensing capabilities of the device.

The illumination unit can be set in manual control mode. In the manual control mode, the illumination unit is initially configured at its default setting, commonly known as the null point, where the tunable lens is set to a 0-degree orientation. This position allows for a baseline depth information capture, which can be analyzed to determine object clarity. If the initial imagery lacks clarity or requires further detail, the user has the option to manually adjust the steering angle. In this situation, an input unit is coupled directly or indirectly to the control unit 36, and the control unit 36 receives the command from the input unit to adjust the steering angle of the beam of the illumination light through dual-layer Ferroelectric Liquid Crystal unit 34. For instance, the angle can be shifted to 10 degrees to target adjacent areas more effectively. The illumination unit is calibrated to adjust the illumination power in relation to the steering angle. This compensates for any potential liquid crystal-induced power losses, enabling the user to fine-tune both the steering angle and light source power to achieve the clearest possible image.

The illumination unit can be set in a dynamic/auto control mode. In the dynamic/auto control mode, the illumination unit is capable of operating autonomously by setting continuous driving signals according to either a predefined free-running mode or a user-customized mode. This flexibility allows the acquisition of depth data across a spectrum of illumination angles and varying light source power levels. By aggregating data over a complete cycle, the illumination unit compiles a comprehensive set of depth data, which enhances 3D imaging across varying distances. Furthermore, the illumination unit can maintain the default angle and operate at a low sampling frequency to conserve power. It intelligently initiates steering adjustments when the sensors detect objects or regions that require enhanced clarity, thereby optimizing power consumption and reducing data overhead.

The ferroelectric liquid crystal used in the illumination unit has remarkably faster switching speeds, which are in the kHz range, compared to the slower Hz range speeds of nematic LCs. This considerable advantage is a result of the unique, single-layered, and cone-confined molecular switching mechanism inherent to the ferroelectric liquid crystal. The ferroelectric liquid crystal facilitates rapid switching, and is also suitable for beam steering applications, enhancing the effectiveness of frame sequential color switching.

Normally, the ferroelectric liquid crystal is not compatible with pure phase modulation devices. This is because their optic axis undergoes movement in a plane that is parallel to the cell substrate, consequently altering the polarization state of the incident light.

In various embodiments in this disclosure, a dual-layer FLC Configuration is proposed. The dual-layer Ferroelectric Liquid Crystal unit consists of two layers of ferroelectric liquid crystals. The first ferroelectric liquid crystal layer 34a is responsible for fast phase modulation, exploiting the quick response time of FLCs for rapid beam steering. The second ferroelectric liquid crystal layer 34b focuses on correcting the polarization state, which is typically altered in FLC systems, ensuring that the light maintains its desired polarization throughout.

In other embodiments, the dual-layer FLC Configuration is cooperated with an AI-enhanced control. The AI component can provide an AI algorithm for phase and polarization management. Because of the rapid steering provided by the dual-layer FLC Configuration, its dual-layer FLC unit can work with and match the operation of the AI component. The AI component can perform complex calculations to predict and adjust the phase modulation required for steering the beam towards the ROI. In addition, the AI component can also control the second ferroelectric liquid crystal layer 34b to dynamically correct any polarization errors introduced by the first ferroelectric liquid crystal layer 34a, maintaining the integrity of the beam.

By precisely controlling the phase modulation in each layer, the dual-layer Ferroelectric Liquid Crystal unit 34 can steer the beam not only left-right and up-down but also along any diagonal or arbitrary path within the X/Y plane. The AI component can adjust the voltage across each FLC cell in real time, allowing for smooth and continuous movement of the dot across the target area.

In an example, the AI component is programmed to understand and target specific ROI based on input parameters or signals for reflected light sensed by an imaging unit of a 3D sensing device or a real-time image analysis of such signals for reflected light by the 3D sensing device. The AI component may be implemented by a processor and a memory. The processor may be a CPU, GPU, and so on. Alternatively, the AI component may be implemented in an ASIC. The AI component may be implemented together with other components in the same chip or may be implemented in a separate chip. The illumination unit can adapt the beam's path and focal properties to optimally illuminate the desired area, even if it requires complex steering patterns. The AI component includes a neural network to implement various AI algorithms. The neural network may take the input parameters or the signals for reflected light or the real-time image analysis as inputs and generate a control signal for the illumination unit to adapt the beam's path and focal properties. The AI algorithms may include linear regression, a decision tree, a random forest algorithm, and so on. The AI algorithm may be combined with a Genetic Algorithm to adjust the node parameters of the neural network so that the AI algorithm can evolve itself and can be adapted to the demand of each individual user.

In an embodiment, the integration of the dual-layer Ferroelectric Liquid Crystal unit with the AI component yields an illumination unit with exceptional speed and precision in-depth measurement and object targeting. This FLC-AI controlled illumination unit offers a significant improvement in resolution over traditional systems and streamlines the intricacies of hardware and software integration typically associated with MEMS scanning methods.

The integration of the dual-layer Ferroelectric Liquid Crystal unit with the AI component is suitable for real-time control and meets the critical demand for rapid and high-resolution imaging, particularly in LiDAR and VCSEL applications. This illumination unit will be a transformative tool in various industries, including autonomous navigation and medical diagnostics. It promises to set a new benchmark in 3D sensing capabilities, enhancing both performance and user experience.

As discussed above, in an embodiment, the three-dimensional depth-sensing device, as shown in FIG. 1 or FIG. 2, may comprise the illumination unit as described above to provide quick and/or precise beam steering.

FIG. 6 shows an electronic device 60. The electronic device 60 comprises a three-dimensional depth-sensing device 61 as described above. For example, the electronic device 60 may be a robot cleaner, a medical imaging device, or an augmented reality device.

Although some specific embodiments of the disclosure have been demonstrated in detail with examples, it should be understood by a person skilled in the art that the above examples are only intended to be illustrative but not to limit the scope of the disclosure.

What is claimed is:

1. An illumination unit for a three-dimensional depth-sensing device, including:
a light source for emitting an illumination light;
a diffuser configured to diffuse the illumination light into diffused illumination light; and
a dual-layer Ferroelectric Liquid Crystal unit, positioned after the diffuser to receive the diffused illumination light,
wherein the dual-layer Ferroelectric Liquid Crystal unit includes a first ferroelectric liquid crystal layer and a second ferroelectric liquid crystal layer,
wherein the first ferroelectric liquid crystal layer adjusts a direction of the diffused illumination light, and
wherein the second ferroelectric liquid crystal layer corrects a polarization change of the illumination light induced by the first ferroelectric liquid crystal layer.

2. The illumination unit according to claim 1, further comprising:
a control unit that is coupled directly or indirectly to the dual-layer Ferroelectric Liquid Crystal unit,
wherein the control unit sends control signals to the dual-layer Ferroelectric Liquid Crystal unit to control at least one of the first ferroelectric liquid crystal layer and the second ferroelectric liquid crystal layer, to steer the illumination light to desired regions of interest.

3. The illumination unit according to claim 2, wherein the control unit further comprises an AI component,
wherein the control signals are generated directly or indirectly by the AI component.

4. The illumination unit according to claim 3, wherein the AI component generates the control signals to control the dual-layer Ferroelectric Liquid Crystal unit to steer the illumination light to desired regions of interest, based on input parameters or a real-time image analysis of an image from a receiver for the three-dimensional depth-sensing device.

5. The illumination unit according to claim 1, wherein the first ferroelectric liquid crystal layer adjusts the direction of the diffused illumination light by altering a phase of the illumination light.

6. The illumination unit according to claim 1, wherein a time period for steering the illumination light to desired regions of interest by the dual-layer Ferroelectric Liquid Crystal unit is less than 1 ms.

7. The illumination unit according to claim 2, further comprising:
a tunable lens unit, positioned after the dual-layer Ferroelectric Liquid Crystal unit and directly or indirectly coupled to the control unit,
wherein the tunable lens unit adjusts an optical characteristic of the illumination light to a desired status.

8. The illumination unit according to claim 1, further comprising:
a lens unit, positioned between the light source and the diffuser and adjust an optical characteristic of the illumination light to be adapted to the diffuser.

9. A three-dimensional depth-sensing device comprising the illumination unit according to claim 1.

10. An electronic device comprising the three-dimensional depth-sensing device according to claim 9.
